(19) United States
(12) Patent Application Publication
(10) Pub. No.: US 2016/0128071 A1
(43) Pub. Date: May 5, 2016

(54) Radio Frequency Coexistence Management For Concurrent Data Traffic Service In Multi-Subscriber-Identity-Module (SIM) Devices

(71) Applicant: QUALCOMM INCORPORATED, San Diego, CA (US)

(72) Inventors: Francis Ming-Meng Ngai, Louisville, CO (US); Chih-Ping Hsu, San Diego, CA (US); Shriram Gurumoorthy, Superior, CO (US); Jan Michael San Pedro, Boulder, CO (US)

(21) Appl. No.: 14/805,766

(22) Filed: Jul. 22, 2015

Related U.S. Application Data
(60) Provisional application No. 62/073,295, filed on Oct. 31, 2014.
(60) Provisional application No. 62/120,103, filed on Feb. 24, 2015.

(51) Int. Cl. H04W 72/08; H04W 72/10; H04B 1/7105; H04W 28/02

(52) U.S. Cl. CPC H04W 72/082; H04W 28/0236; H04W 72/10; H04B 1/71055

(57) ABSTRACT

Various embodiments provide methods, devices, and non-transitory processor-readable storage media for avoiding coexistence interference between radio access technologies (RATs) operating on a multi-active communication device. Various embodiments provide methods, devices, and non-transitory processor-readable storage media to leverage an ability of a multi-active communication device to manage two RATs and/or subscriptions to protect on-demand traffic service performance, such as Multimedia Messaging Service (“MMS”) service performance, when inter-RAT coexistence interference is occurring, or is likely to occur, between an on-demand traffic service, such as a MMS service, and a data service. In some embodiments, an on-demand traffic service may be a bursty on-demand traffic service.

### RELATED APPLICATIONS

This application claims the benefit of priority to U.S. Provisional Patent Application No. 62/073,295 entitled “Radio Frequency Coexistence Management For Concurrent Data and MMS In Multi-SIM Devices” filed Oct. 31, 2014, and U.S. Provisional Patent Application No. 62/120,103 entitled “Radio Frequency Coexistence Management For Concurrent Data and a Bursty On-Demand Traffic Service In Multi-SIM Devices” filed Feb. 24, 2015, the entire contents of which are hereby incorporated by reference.

### BACKGROUND

Some new designs of multi-active communication devices—such as smart phones, tablet computers, and laptop computers—include two or more radio access technologies (“RATs”) that enable the devices to connect to two or more radio access networks. Examples of radio access networks include Global System for Mobile Communications (GSM), Time Division—Synchronous Code Division Multiple Access (TD-SCDMA), Code Division Multiple Access 2000 (CDMA2000), Long Term Evolution (LTE), and Wideband Code Division Multiple Access (WCDMA). Such multi-active communication devices (sometimes referred to as “multi-active communication devices”) may also include two or more radio-frequency (RF) communication circuits or “RF resources” to provide users with access to separate networks via the two or more RATs.

Multi-active communication devices may include multi-active communication devices (i.e., multi-Subscriber-Identity-Module (SIM), multi-active or “MSMA” communication devices) with a plurality of SIM cards that are each associated with a different RAT and utilize a different RF resource to connect to a separate mobile telephony network. An example multi-active communication device is a “dual-SIM-dual-active” or “DSDA” communication device, which includes two SIM cards/subscriptions associated with two mobile telephony networks. Further, some newer multi-active communication devices may include one or more SIMs/subscriptions capable of using multiple RATs (sometimes referred to as “global mode” subscriptions) simultaneously or at different times. For example, a global mode subscription may be included on a single-SIM communication device, such as a simultaneous GSM +LTE (“SGLTE”) communication device, which includes one SIM card/subscription associated with two RATs that each use an RF resource to connect to two separate mobile networks simultaneously on behalf of the one subscription.

When a multi-active communication device includes a plurality of RATs, each RAT on the device may utilize a different RF resource to communicate with the network associated with the RAT at any time. For example, a first RAT (e.g., a GSM RAT) may use a first transceiver to transmit to a GSM base station at the same time a second RAT (e.g., a WCDMA RAT) uses a second transceiver to transmit to a WCDMA base station. However, because of the proximity of the antennas of the RF resources included in a multi-active communication device, the simultaneous use of the RF resources may cause one or more RF resources to desensitize or interfere with the ability of the other RF resources to operate normally.

Generally, receiver desensitization (referred to as “de-sense”) or degradation of receiver sensitivity may result from noise interference of a nearby transmitter. For example, when two radios are close together with one transmitting on the uplink—the aggressor communication activity (“aggressor”)—and the other receiving on the downlink—the victim communication activity (“victim”)—signals from the aggressor's transmitter may be picked up by the victim's receiver or otherwise interfere with reception of a weaker signal (e.g., from a distant base station). As a result, the received signals may become corrupted and difficult or impossible for the victim to decode. Receiver de-sense presents a design and operational challenge for multi-radio devices, such as multi-active communication devices, due to the proximity of transmitters in these devices.

### SUMMARY

Various embodiments provide methods, devices, and non-transitory processor-readable storage media for avoiding coexistence interference between radio access technologies (RATs) operating on a multi-active communication device. Various embodiments provide methods, devices, and non-transitory processor-readable storage media to leverage an ability of a multi-active communication device to manage two RATs and/or subscriptions to protect an on-demand traffic service performance, such as a Multimedia Messaging Service (“MMS”) service performance, when inter-RAT coexistence interference is occurring, or is likely to occur, between the on-demand traffic service and a data service. Various embodiments may include determining whether an on-demand traffic service on a first RAT and a data service on a second RAT are occurring concurrently. In response to determining that the on-demand traffic service on the first RAT and the data service on the second RAT are occurring concurrently, methods of the various embodiments may include determining whether the data service on the second RAT or the on-demand traffic service on the first RAT is an aggressor activity. In response to determining that the data service on the second RAT or the on-demand traffic service on the first RAT is the aggressor activity methods of the various embodiments may include enabling a radio frequency (RF) coexistence mitigation technique on the first RAT or the second RAT associated with the aggressor activity.

In some embodiments, in response to determining that the data service on the second RAT or the on-demand traffic service on the first RAT is the aggressor activity methods of the various embodiments may include disabling a RF coexistence mitigation technique on the first RAT or the second RAT that is not associated with the aggressor activity. In some embodiments, disabling a RF coexistence mitigation technique on the first RAT or the second RAT not associated with the aggressor activity may include not enabling a RF coexistence mitigation technique on the first RAT or the second RAT not associated with the aggressor activity

In some embodiments, determining whether the data service on the second RAT or the on-demand traffic service on the first RAT is an aggressor activity may include determining whether the data service on the second RAT is an aggressor activity. In response to determining that the data service on the second RAT is the aggressor activity such embodiments may further include enabling a RF coexistence mitigation technique on the second RAT. In response to determining that the data service on the second RAT is not the aggressor activity such embodiments may further include disabling RF coexistence mitigation on the first RAT or the second RAT not associated with the aggressor activity.

In some embodiments, determining whether the data service on the second RAT or the on-demand traffic service on the first RAT is an aggressor activity may include determining whether the on-demand traffic service on the first RAT is an aggressor. In response to determining that the on-demand traffic service on the first RAT is the aggressor activity such embodiments may further include enabling a RF coexistence mitigation technique on the first RAT. In response to determining that the on-demand traffic service on the first RAT is not the aggressor activity such embodiments may further include disabling a RF coexistence mitigation technique on the first RAT or the second RAT not associated with the aggressor activity.

In some embodiments, the on-demand traffic service may be a bursty on-demand traffic service.

In some embodiments, the RF coexistence mitigation may include power back off, blanking, or both operations.

In some embodiment, the methods may further include determining whether the data service on the second RAT meets a blanking threshold, and invoking flow control on the second RAT in response to determining that the data service on the second RAT meets a blanking threshold.

In some embodiments, the methods may further include determining whether a coexistence event between the data service and the on-demand traffic service is occurring or likely to occur, and applying one or more coexistence rules to prioritize packets of the data service in response to determining that a coexistence event between the data service and the on-demand traffic service is occurring or likely to occur. In such embodiments, applying the one or more coexistence rules to prioritize packets of the on-demand traffic service may include always prioritizing the packets of the on-demand traffic service over packets of the data service.

In some, the methods may further include determining whether a coexistence event between the data service and the on-demand traffic service is occurring or likely to occur, and applying one or more coexistence rules to prioritize packets of the on-demand traffic service in response to determining that a coexistence event between the data service and the on-demand traffic service is occurring or likely to occur. In such embodiments, applying one or more coexistence rules to prioritize packets of the on-demand traffic service may include always prioritizing the packets of the on-demand traffic service over packets of the data service. In such embodiments, applying one or more coexistence rules to prioritize packets of the on-demand traffic service may include determining a status of a data service packet and an on-demand traffic service packet, prioritizing the on-demand traffic service packet over the data service packet in response to determining that the data service packet is a payload packet or the on-demand traffic service packet is a minimum link packet, and prioritizing the data service packet over the on-demand traffic service packet in response to determining that the data service packet is a minimum link packet and the on-demand traffic service packet is a payload packet. In such embodiments, applying one or more coexistence rules to prioritize packets of the on-demand traffic service may include determining a status of a data service packet and an on-demand traffic service packet, and prioritizing the data service packet over the on-demand traffic service packet in response to determining that the on-demand traffic service packet is a keep-alive message.

Various embodiments may include a multi-active communication device configured with processor-executable instructions to perform operations of the methods described herein.

Various embodiments may include a multi-active communication device having means for performing functions of the operations of the methods described herein.

Various embodiments may include non-transitory processor-readable media on which are stored processor-executable instructions configured to cause a processor of multi-active communication device to perform operations of the methods described herein.

### BRIEF DESCRIPTION OF THE DRAWINGS

The accompanying drawings, which are incorporated herein and constitute part of this specification, illustrate exemplary embodiments of the invention, and together with the summary and the detailed description, serve to explain the features of the invention.

FIG. 1 is a communication system block diagram of mobile telephony networks suitable for use with various embodiments.

FIG. 2 is a component block diagram of a multi-active communication device according to various embodiments.

FIG. 3 is a component block diagram illustrating the interaction between components of different transmit/receive chains in a multi-active communication device according to various embodiments.

FIG. 4 is a process flow diagram illustrating a method for managing a coexistence event between on-demand traffic service and a data service according to various embodiments.

FIG. 5A is a process flow diagram illustrating a method for applying data and on-demand traffic service coexistence rules to prioritize/de-prioritize on-demand traffic service packets and data packets according to various embodiments.

FIG. 5B is a process flow diagram illustrating another method for applying data and on-demand traffic service coexistence rules to prioritize/de-prioritize on-demand traffic service packets and data packets according to various embodiments.

FIG. 5C is a process flow diagram illustrating a further method for applying data and on-demand traffic service coexistence rules to prioritize/de-prioritize on-demand traffic service packets and data packets according to various embodiments.

FIG. 6 is a process flow diagram illustrating a method for managing a coexistence event between on-demand traffic service and a data service according to various embodiments.

FIG. 7 is a component block diagram of a multi-active communication device suitable for implementing methods of the various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

As used herein, the term “multi-active communication device” is used to refer to any one or all of cellular telephones, smart phones, personal or mobile multi-media players, personal data assistants, laptop computers, personal computers, tablet computers, smart books, palm-top computers, wireless electronic mail receivers, multimedia Internet-enabled cellular telephones, and similar personal electronic devices that include a programmable processor, memory, and circuitry for connecting to at least two mobile communication networks. The various aspects may be useful in multi-active communication devices, such as smart phones, and so such devices are referred to in the descriptions of various embodiments. However, the embodiments may be useful in any electronic devices, such as a DSDA communication device, that may individually maintain a plurality of RATs that may simultaneously utilize a plurality of separate RF resources.

As used herein, the terms “SIM”, “SIM card,” and “subscriber identification module” are used interchangeably to refer to a memory that may be an integrated circuit or embedded into a removable card, and that stores an International Mobile Subscriber Identity (IMSI), related key, and/or other information used to identify and/or authenticate a wireless device on a network and enable a communication service with the network. Because the information stored in a SIM enables the wireless device to establish a communication link for a particular communication service with a particular network, the term “subscription” is also used herein as a shorthand reference to the communication service associated with and enabled by the information stored in a particular SIM as the SIM and the communication network, as well as the services and subscriptions supported by that network, correlate to one another.

Multi-active communication devices have a plurality of RF resources capable of supporting a plurality of RATs capable of receiving and transmitting simultaneously. As described, one or more RATs on a multi-active communication device may negatively affect the performance of other RATs operating on the multi-active communication device. For example, a multi-active communication device may suffer from inter-RAT coexistence interference when an aggressor RAT is attempting to transmit while a victim RAT is simultaneously attempting to receive transmissions. During such a “coexistence event,” the aggressor RAT's transmissions may cause severe impairment to the victim RAT's ability to receive transmissions. This interference may be in the form of blocking interference, harmonics (or subharmonics), intermodulation, and other noises and distortion received by the victim. Such interference may significantly degrade the victim RAT's receiver sensitivity, voice call quality, and data throughput. These effects may also result in a reduced network capacity.

Currently, there are solutions for mitigating victim RAT de-sense that are implemented on conventional multi-active communication devices. For example, in some solutions, a multi-active communication device configures the aggressor RAT to reduce or zero the aggressor RAT's transmit power while the victim RAT is receiving transmissions. In other words, the device reduces the aggressor RAT's transmit power or, in some extreme cases, zeroes the aggressor RAT's transmit power (sometimes referred to as implementing transmit (“Tx”) blanking) in order to reduce or eliminate the victim RAT's de-sense. However, such conventional solutions can impact communication performance and may be less desirable for managing coexistence events involving on-demand traffic services, such as Multimedia Messaging Service (“MMS”), Bearer Independent Protocol (BIP) for SIM content update, and location services, in some networks and circumstances.

In some networks, on-demand traffic services, such as MMS services, are separated from non-on-demand traffic service (e.g., non-MMS data services)(referred to herein generally as “data services”). A multi-active communication device in such on-demand traffic service and data service separated networks may be required to concurrently support both an on-demand traffic service (e.g., a MMS service) and a data service. In on-demand traffic service and data service separated networks, a multi-active communication device may be configured to establish a connection to the network to support a data service as soon as the multi-active communication device is powered up, and the connection supporting the data service may not be torn down by the multi-active communication device regardless of whether or not the data service is in use and/or whether or not there are packets to be sent or to be received for the data service. Additionally, in on-demand traffic service and data service separated networks, a multi-active communication device may be configured to not establish a connection to the network to support an on-demand traffic service until there are packets to be sent or to be received for the on-demand traffic service. Further, in on-demand traffic service and data service separated networks, the connection supporting the on-demand traffic service may be torn down whenever the on-demand service is not in use and/or there are no packets to be sent or to be received for the on-demand traffic service. In such multi-active communication devices concurrently supporting both on-demand traffic services and data services, inter-RAT coexistence interference may be experienced when a first subscription is providing a data service while a second subscription is providing an on-demand traffic service, such as a MMS service.

The term “on-demand traffic service” is used herein merely as an example of a traffic service, such as an MMS service, that may be separated from a data service in some networks. As used herein, “on-demand traffic service” may be any type service in which a connection to support the service is established when there are packets to be sent and/or to be received by the service and the connection is torn down when there are not packets to be sent and/or to be received by the service. “On-demand traffic services” may include services with bursty traffic (i.e., traffic that may be sent and/or that may be received for a limited period of time, such as a period of time of less than 0.5 seconds, of 0.5 seconds, of 0.5 seconds to 1.0 seconds, of 1.0 second, of greater than 1.0 second, etc.). “On-demand traffic services” with bursty traffic may be referred to generally as “bursty on-demand traffic services” or “bursty traffic services.” While “on-demand traffic services” may include services with bursty traffic, all “on-demand traffic services” may not include bursty traffic.

In overview, various embodiments leverage the ability of a multi-active communication device to manage two RATs and/or subscriptions to protect on-demand traffic service performance, such as MMS service performance, when inter-RAT coexistence interference is occurring, or is likely to occur, between an on-demand traffic service and a data service. Specifically, a processor on the multi-active communication device may determine whether there is, or there is a likelihood of, inter-RAT coexistence interference (i.e., a coexistence event) occurring between a first RAT and/or subscription supporting an on-demand traffic service, such as a MMS service, and a second RAT and/or subscription supporting a data service. Coexistence events may occur when both the data service and on-demand traffic service intend to send and/or receive in at the same time. The existence or likelihood of such a coexistence event may be determined based on frequency bands/channels currently available to each of the first RAT and the second RAT that are known to interfere with each other. The device processor may monitor for coexistence events on a per slot or per packet basis.

In response to determining that there is, or is likely to be, inter-RAT coexistence interference occurring between a first RAT and/or subscription supporting an on-demand traffic service, such as an MMS service, and a second RAT and/or subscription supporting a data service, the processor of the multi-active communication device may enable and/or disable coexistence mitigations for the RATs, such as power back off settings, blanking (e.g., Rx and/or Tx blanking), etc. in order to protect the data service or the on-demand traffic service communications, such as the MMS communications.

In various embodiments, the multi-active communication device processor may invoke uplink flow control on the RAT supporting the data service when one or more thresholds and/or criteria for invoking blanking (e.g., Rx and/or Tx blanking) on the RAT supporting the data service are satisfied Implementing uplink flow control on the RAT supporting the data service may reduce the likelihood of coexistence events occurring between an on-demand traffic service, such as a MMS service, and the data service because the amount of packets on the uplink for the data service may be reduced.

In various embodiments, the device processor may apply data and on-demand traffic service coexistence rules, such as MMS coexistence rules, to prioritize/de-prioritize on-demand traffic service packets (e.g., MMS packets) and data packets when a coexistence event occurs between the on-demand traffic service and the data service. In some embodiments, such data and coexistence rules may be relatively simple directing the device processor to prioritize any on-demand traffic service packet and de-prioritize any data packet when a coexistence event occurs. In this manner, an on-demand traffic service, such as a MMS service, may always win over a data service.

In some embodiments, such data and coexistence rules may direct the device processor to prioritize any data service packet and de-prioritize any on-demand traffic service packet when a coexistence event occurs. In this manner, a data service may always win over an on-demand traffic service, such as a MMS service. Such data and coexistence rules that prioritize any data service packet and de-prioritize any on-demand traffic service packet when a coexistence event occurs may be applied by the device processor when the on-demand traffic service is not a time-sensitive service.

In other embodiments, data and coexistence rules may be more complex directing the device processor to make conditional exceptions to prioritize selected data packets over on-demand traffic service packets when coexistence events occur. For example, a data and coexistence rule may direct the device processor to prioritize minimum link data packets necessary to keep a data connection of the data service alive over payload MMS packets. In this manner, a condition exception in a data and coexistence rule may provide a best effort prevention of radio link failure (RLF) for the data service. As another example, a data and coexistence rule may direct the device processor to prioritize packets of the data service over keep-alive message packets of the MMS service.

For ease of reference, the descriptions of some embodiments may refer to MMS services as an example of on-demand traffic services that may benefit from various embodiments. The discussions of MMS services are provided merely as examples to better illustrate the aspects of various embodiments, and are not intended to limit the claims to MMS services unless specifically recited. Other on-demand traffic services, such as BIP for SIM content update, location services, etc., may benefit from the various embodiments, and other types of on-demand traffic services, such as BIP for SIM content update, location services, etc., may be substituted in the various examples discussed herein.

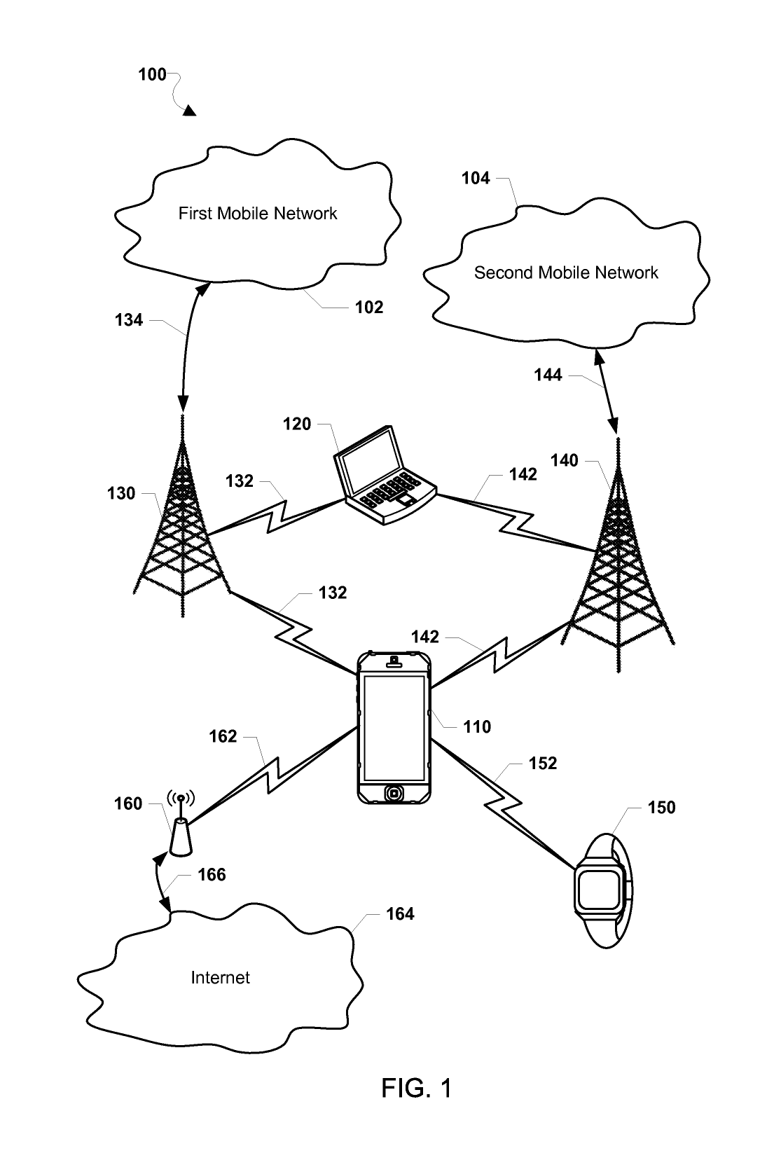

Various embodiments may be implemented within a variety of communication systems 100 that include at least two mobile telephony networks, an example of which is illustrated in FIG. 1. A first mobile network 102 and a second mobile network 104 typically each include a plurality of cellular base stations (e.g., a first base station 130 and a second base station 140). A first multi-active communication device 110 may be in communication with the first mobile network 102 through a cellular connection 132 to the first base station 130. The first multi-active communication device 110 may also be in communication with the second mobile network 104 through a cellular connection 142 to the second base station 140. The first base station 130 may be in communication with the first mobile network 102 over a wired connection 134. The second base station 140 may be in communication with the second mobile network 104 over a wired connection 144.

A second multi-active communication device 120 may similarly communicate with the first mobile network 102 through the cellular connection 132 to the first base station 130. The second multi-active communication device 120 may communicate with the second mobile network 104 through the cellular connection 142 to the second base station 140. The cellular connections 132 and 142 may be made through two-way wireless communication links, such as 4G, 3G, Code Division Multiple Access (CDMA), Time Division Multiple Access (TDMA), WCDMA, GSM, LTE, and other mobile telephony communication technologies.

While the multi-active communication devices 110, 120 are shown connected to the mobile networks 102, 104, in some embodiments (not shown), the multi-active communication devices 110, 120 may include one or more subscriptions to two or more mobile networks 102, 104 and may connect to those networks as well.

In some embodiments, the first multi-active communication device 110 may establish a wireless connection 152 with a peripheral device 150 used in connection with the first multi-active communication device 110. For example, the first multi-active communication device 110 may communicate over a Bluetooth® link with a Bluetooth-enabled personal computing device (e.g., a “smart watch”). In some embodiments, the first multi-active communication device 110 may establish a wireless connection 162 with a wireless access point 160, such as over a Wi-Fi connection. The wireless access point 160 may be configured to connect to the Internet 164 or another network over a wired connection 166.

While not illustrated, the second multi-active communication device 120 may similarly be configured to connect with the peripheral device 150 and/or the wireless access point 160 over wireless links.

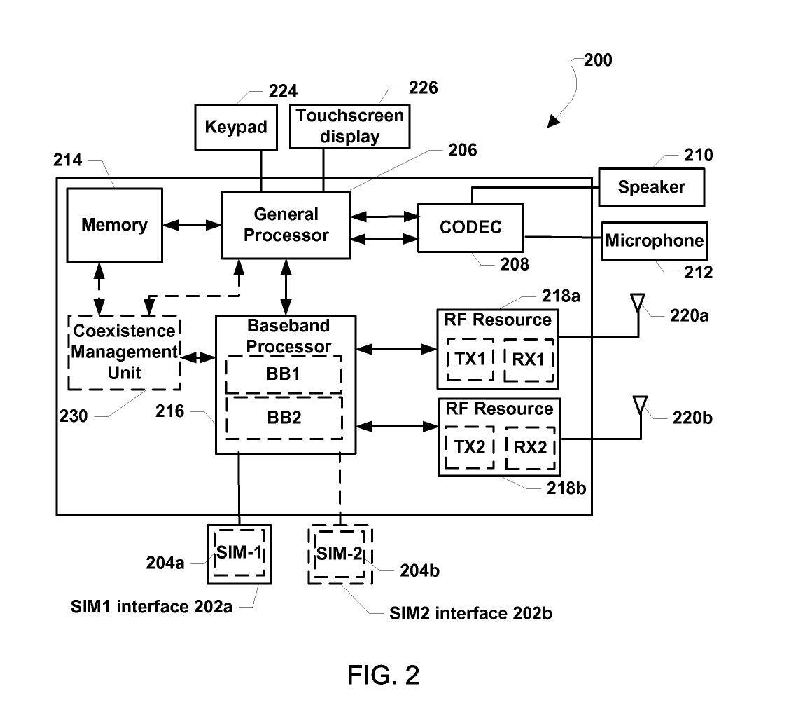

FIG. 2 is a functional block diagram of a multi-active communication device 200 suitable for implementing various embodiments. According to various embodiments, the multi-active communication device 200 may be similar to one or more of the multi-active communication devices 110, 120 as described with reference to FIG. 1. With reference to FIGS. 1-2, the multi-active communication device 200 may include a first SIM interface 202a, which may receive a first identity module SIM-1 204a that is associated with a first subscription. In optional embodiments, the multi-active communication device 200 may optionally include a second SIM interface 202b, which may receive an optional second identity module SIM-2 204b that is associated with a second subscription.

A SIM in various embodiments may be a Universal Integrated Circuit Card (UICC) that is configured with SIM and/or USIM applications, enabling access to, for example, GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card. Each SIM card may have a CPU, ROM, RAM, EEPROM, and I/O circuits.

A SIM used in various embodiments may contain user account information, an international mobile subscriber identity (IMSI), a set of SIM application toolkit (SAT) commands, and storage space for phone book contacts. A SIM card may further store home identifiers (e.g., a System Identification Number (SID)/Network Identification Number (NID) pair, a Home PLMN (HPLMN) code, etc.) to indicate the SIM card network operator provider. An Integrated Circuit Card Identity (ICCID) SIM serial number is printed on the SIM card for identification. However, a SIM may be implemented within a portion of memory of the multi-active communication device 200 (e.g., memory 214), and thus need not be a separate or removable circuit, chip or card.

The multi-active communication device 200 may include at least one controller, such as a general processor 206, which may be coupled to a coder/decoder (CODEC) 208. The CODEC 208 may in turn be coupled to a speaker 210 and a microphone 212. The general processor 206 may also be coupled to the memory 214. The memory 214 may be a non-transitory computer readable storage medium that stores processor-executable instructions. For example, the instructions may include routing communication data relating to the first or second subscription though a corresponding baseband-RF resource chain.

The memory 214 may store an operating system (OS), as well as user application software and executable instructions. The memory 214 may also store application data, such as an array data structure.

The general processor 206 and the memory 214 may each be coupled to at least one baseband modem processor 216. Each SIM in the multi-active communication device 200 (e.g., the SIM-1 204a and the SIM-2 204b) may be associated with a baseband-RF resource chain. A baseband-RF resource chain may include the baseband modem processor 216, which may perform baseband/modem functions for communicating with/controlling a RAT, and may include one or more amplifiers and radios, referred to generally herein as RF resources (e.g., RF resources 218a, 218b). In some embodiments, baseband-RF resource chains may share the baseband modem processor 216 (i.e., a single device that performs baseband/modem functions for all SIMs on the multi-active communication device 200). In other embodiments, each baseband-RF resource chain may include physically or logically separate baseband processors (e.g., BB1, BB2).

In some embodiments, the RF resources 218a, 218b may be associated with different RATs. For example, a first RAT (e.g., a GSM RAT) may be associated with the RF resource 218a, and a second RAT (e.g., a CDMA or WCDMA RAT) may be associated with the RF resource 218b. The RF resources 218a, 218b may each be transceivers that perform transmit/receive functions on behalf of their respective RATs. The RF resources 218a, 218b may also include separate transmit and receive circuitry, or may include a transceiver that combines transmitter and receiver functions. The RF resources 218a, 218b may each be coupled to a wireless antenna (e.g., a first wireless antenna 220a or a second wireless antenna 220b). The RF resources 218a, 218b may also be coupled to the baseband modem processor 216.

In some embodiments, the general processor 206, the memory 214, the baseband processor(s) 216, and the RF resources 218a, 218b may be included in the multi-active communication device 200 as a system-on-chip. In some embodiments, the first and second SIMs 204a, 204b and their corresponding interfaces 202a, 202b may be external to the system-on-chip. Further, various input and output devices may be coupled to components on the system-on-chip, such as interfaces or controllers. Example user input components suitable for use in the multi-active communication device 200 may include, but are not limited to, a keypad 224, a touchscreen display 226, and the microphone 212.

In some embodiments, the keypad 224, the touchscreen display 226, the microphone 212, or a combination thereof, may perform the function of receiving a request to initiate an outgoing call. For example, the touchscreen display 226 may receive a selection of a contact from a contact list or receive a telephone number. In another example, either or both of the touchscreen display 226 and the microphone 212 may perform the function of receiving a request to initiate an outgoing call. For example, the touchscreen display 226 may receive a selection of a contact from a contact list or to receive a telephone number. As another example, the request to initiate the outgoing call may be in the form of a voice command received via the microphone 212. Interfaces may be provided between the various software modules and functions in the multi-active communication device 200 to enable communication between them, as is known in the art.

Functioning together, the two SIMs 204a, 204b, the baseband modem processor 216, the RF resources 218a, 218b, and the wireless antennas 220a, 220b may constitute two or more RATs. For example, a SIM, baseband processor and RF resource may be configured to support two different RATs, such as GSM and WCDMA. More RATs may be supported on the multi-active communication device 200 by adding more SIM cards, SIM interfaces, RF resources, and/or antennae for connecting to additional mobile networks.

The multi-active communication device 200 may include a coexistence management unit 230 configured to manage and/or schedule the RATs' utilization of the RF resources 218a, 218b. In some embodiments, the coexistence management unit 230 may be implemented within the general processor 206. In some embodiments, the coexistence management unit 230 may be implemented as a separate hardware component (i.e., separate from the general processor 206). In some embodiments, the coexistence management unit 230 may be implemented as a software application stored within the memory 214 and executed by the general processor 206. The coexistence management unit 230 may manage two RATs and/or subscriptions to protect on-demand traffic service performance, such as MMS service performance, when inter-RAT coexistence interference is occurring, or is likely to occur, between an on-demand traffic service, such as a MMS service, and a data service as described herein.

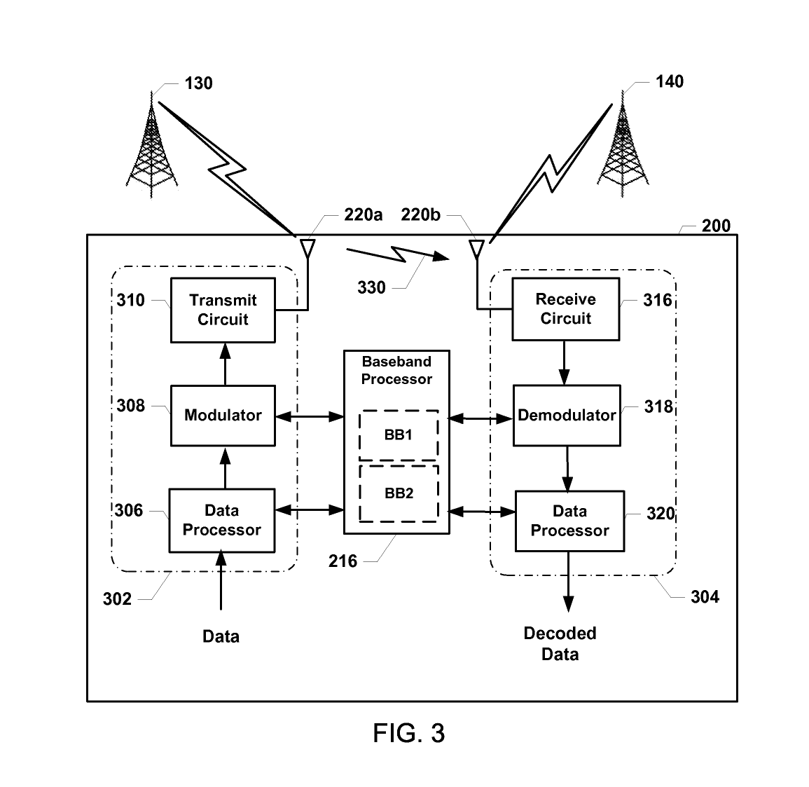

FIG. 3 is a block diagram of transmit and receive components in separate RF resources on the multi-active communication device 200 described with reference to FIGS. 1-2, according to various embodiments. With reference to FIGS. 1-3, a transmitter 302 may be part of the RF resource 218a, and a receiver 304 may be part of the RF resource 218b. In some embodiments, the transmitter 302 may include a data processor 306 that may format, encode, and interleave data to be transmitted. The transmitter 302 may include a modulator 308 that modulates a carrier signal with encoded data, such as by performing Gaussian minimum shift keying (GMSK). One or more transmit circuits 310 may condition the modulated signal (e.g., by filtering, amplifying, and upconverting) to generate an RF modulated signal for transmission. The RF modulated signal may be transmitted to the first base station 130 via the first wireless antenna 220a, for example.

In the receiver 304, the second wireless antenna 220b may receive RF modulated signals from the second base station 140 on the second wireless antenna 220b. However, the second wireless antenna 220b may also receive some RF signaling 330 from the transmitter 302, which may ultimately compete with the desired signal received from the second base station 140. One or more receive circuits 316 may condition (e.g., filter, amplify, and downconvert) the received RF modulated signal, digitize the conditioned signal, and provide samples to a demodulator 318. The demodulator 318 may extract the original information-bearing signal from the modulated carrier wave, and may provide the demodulated signal to a data processor 320. The data processor 320 may de-interleave and decode the signal to obtain the original, decoded data, and may provide decoded data to other components in the multi-active communication device 200. Operations of the transmitter 302 and the receiver 304 may be controlled by a processor, such as the baseband modem processor 216. In various embodiments, each of the transmitter 302 and the receiver 304 may be implemented as circuitry that may be separated from their corresponding receive and transmit circuitries (not shown). Alternatively, the transmitter 302 and the receiver 304 may be respectively combined with corresponding receive circuitry and transmit circuitry, for example, as transceivers associated with the SIM-1 204a and the SIM-2 204b.

Receiver de-sense may occur when transmissions by a first RAT on the uplink (e.g., the RF signaling 330) interferes with receive activity on a different transmit/receive chain associated with a second RAT. The signals received by the second RAT may become corrupted and difficult or impossible to decode as a result of the de-sense or interference. Further, noise from the transmitter 302 may be detected by a power monitor (not shown) that measures the signal strength of surrounding cells, which may cause the multi-active communication device 200 to falsely determine the presence of a nearby cell site.

Because inter-RAT coexistence interference may severely degrade the performance of RATs affected by such interference, various embodiments protect on-demand traffic service performance, such as MMS service performance, when inter-RAT coexistence interference is occurring, or is likely to occur, between an on-demand traffic service, such as a MMS service, and a data service.

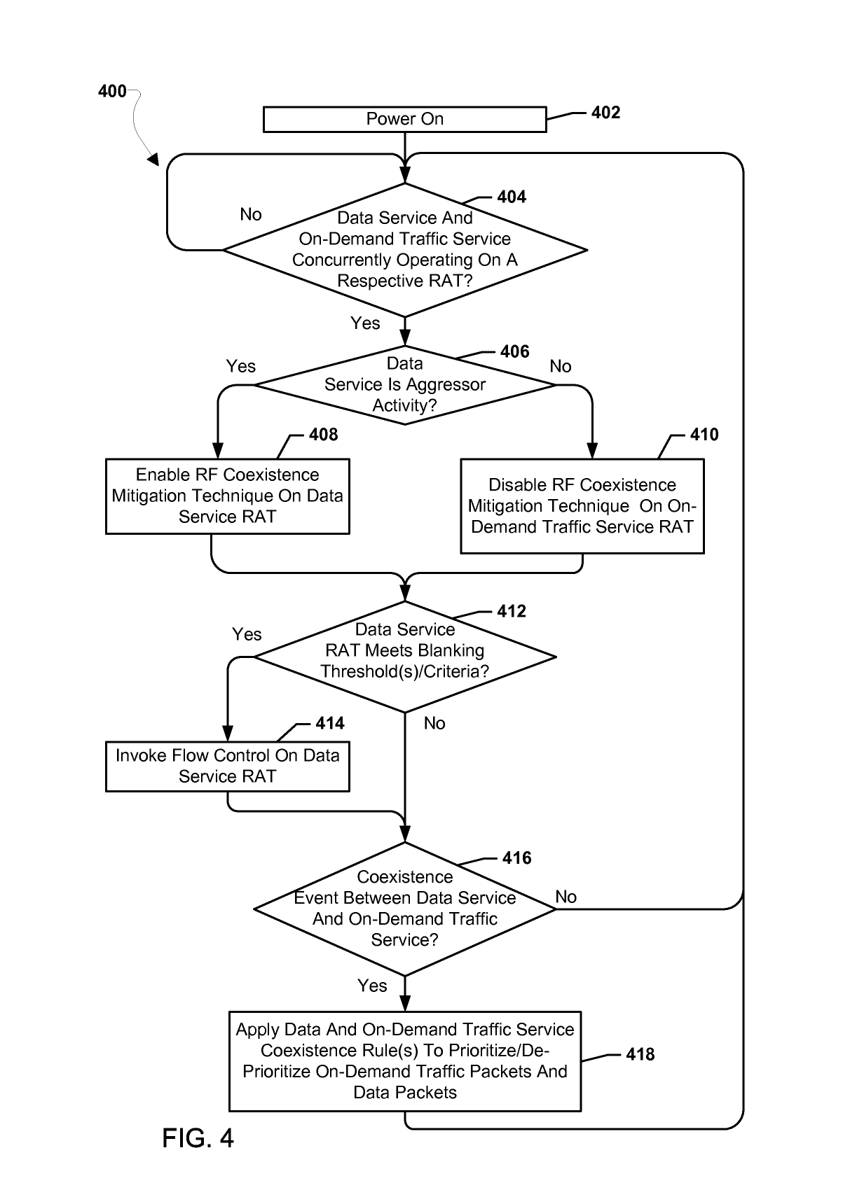

FIG. 4 illustrates a method 400 for managing a coexistence event between an on-demand traffic service, such as a MMS service, and a data service according to various embodiments. The method 400 may be implemented with a processor (e.g., the general processor 206 of FIG. 2, the baseband modem processor 216, the coexistence management unit 230, a separate controller, and/or the like) on a multi-active communication device (e.g., the multi-active communication device 110, 200 described with reference to FIGS. 1-3). In various embodiments, the operations of method 400 may be performed by the device processor on a per slot or per packet basis. With reference to FIGS. 1-4, the device processor may begin performing operations of the method 400 in response to the multi-active communication device's powering on in block 402.

In determination block 404 the device processor may determine whether a data service and on-demand traffic service, such as a MMS service, are concurrently operating on a respective RAT of the device. (e.g., a first RAT providing a MMS service and a second RAT providing a data service). In response to determining that a data service and on-demand traffic service are not concurrently operating (i.e., determination block 404=“No”), the device processor may continue to monitor the status of the RATs of the device in determination block 404.

In response to determining that a data service and on-demand traffic service are concurrently operating (i.e., determination block 404=“Yes”), the device processor may determine whether the data service is the aggressor activity in determination block 406. For example, the device processor may determine whether the data service is transmitting on the uplink to determine whether the data service is the aggressor activity.

In response to determining that the data service is the aggressor activity (i.e., determination block 406=“Yes”), the device processor may enable one or more RF coexistence mitigation technique (e.g., Tx blanking, power back off, etc.) on the data service's RAT in block 408. As examples, the device processor may enable power back off and/or blanking on the RAT associated with the data service.

In response to determining that the data service is not the aggressor activity and the on-demand traffic service, such as the MMS service, is the aggressor activity (i.e., determination block 406=“No”), the device processor may disable or otherwise not implement one or more RF coexistence mitigation technique on the on-demand traffic service RAT, such as the MMS service RAT, in block 410. As examples, the device processor may prevent power back off and/or blanking on the RAT associated with the data service.

In response to enabling or disabling the RF coexistence mitigation techniques in blocks 408 or 410, the device processor may determine whether the data service RAT meets or exceeds one or more blanking thresholds or criteria in determination block 412. For example, the device processor may determine whether the data service RAT meets or exceeds one or more blanking thresholds or criteria by comparing attributes of the data service to thresholds and/or criteria stored in a memory (e.g., 214).

In response to determining that the data service RAT meets a blanking threshold or criteria (i.e., determination block 412=“Yes”), the device processor may invoke flow control on the data service RAT, in block 414. In this manner, the uplink flow control on the RAT supporting the data service may reduce the likelihood of coexistence events occurring between an on-demand traffic service, such as a MMS service, and the data service because the amount of packets on the uplink for the data service may be reduced.

In response to invoking flow control on the data service RAT in block 414 or in response to determining that the data service RAT does not meet a blanking threshold or criteria (i.e., determination block 412=“No”), the device processor may determine whether a coexistence event between the data service and the on-demand traffic service, such as the MMS service, is occurring or will occur, in determination block 416. Coexistence events may occur when both the data service and on-demand traffic service, such as the MMS service, intend to send and/or receive at (or near) the same time. The device processor may monitor for coexistence events on a per-slot or per-packet basis. As an example, the device processor may perform a table lookup of frequency bands/channels available to the RAT associated with the data service and the RAT associated with the MMS service in an interference data table in order to identify frequency-band/channel combinations that may result in inter-RAT coexistence interference to determine that coexistence events are occurring or will occur.

In response to determining that a coexistence event is not occurring or will not occur between the data service and on-demand traffic service (i.e., determination block 416=“No”), the device processor may determine whether the data service and on-demand traffic service, such as the MMS service, are concurrently operating in determination block 404.

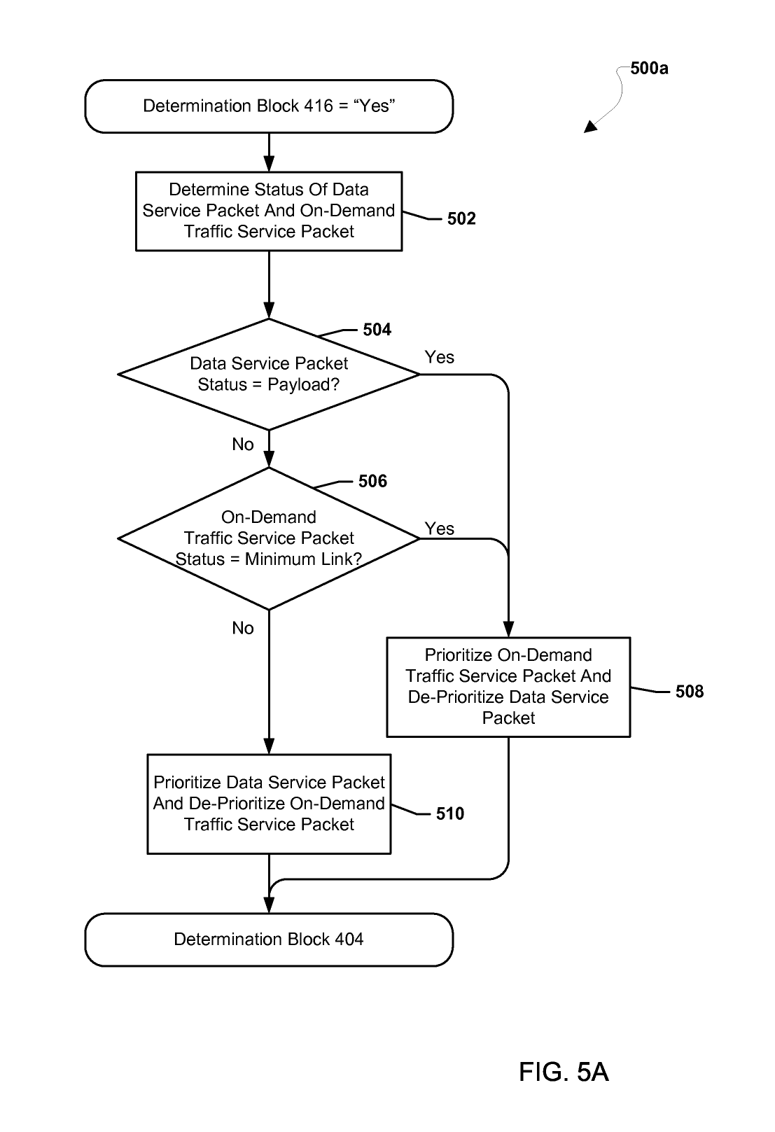

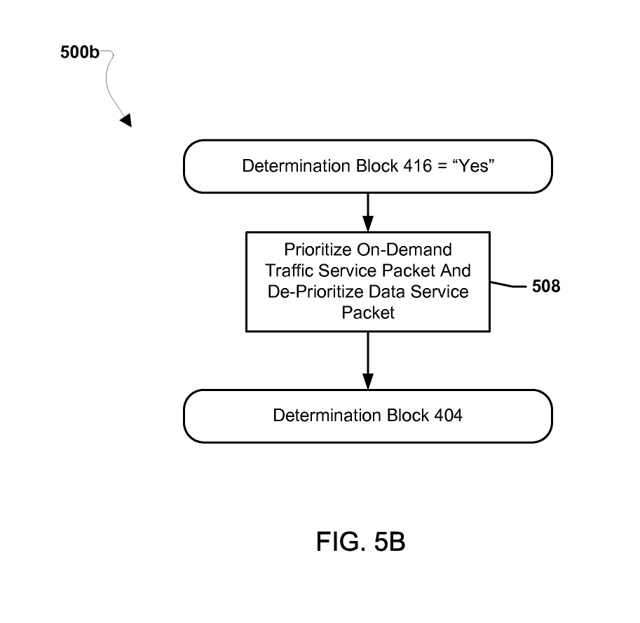

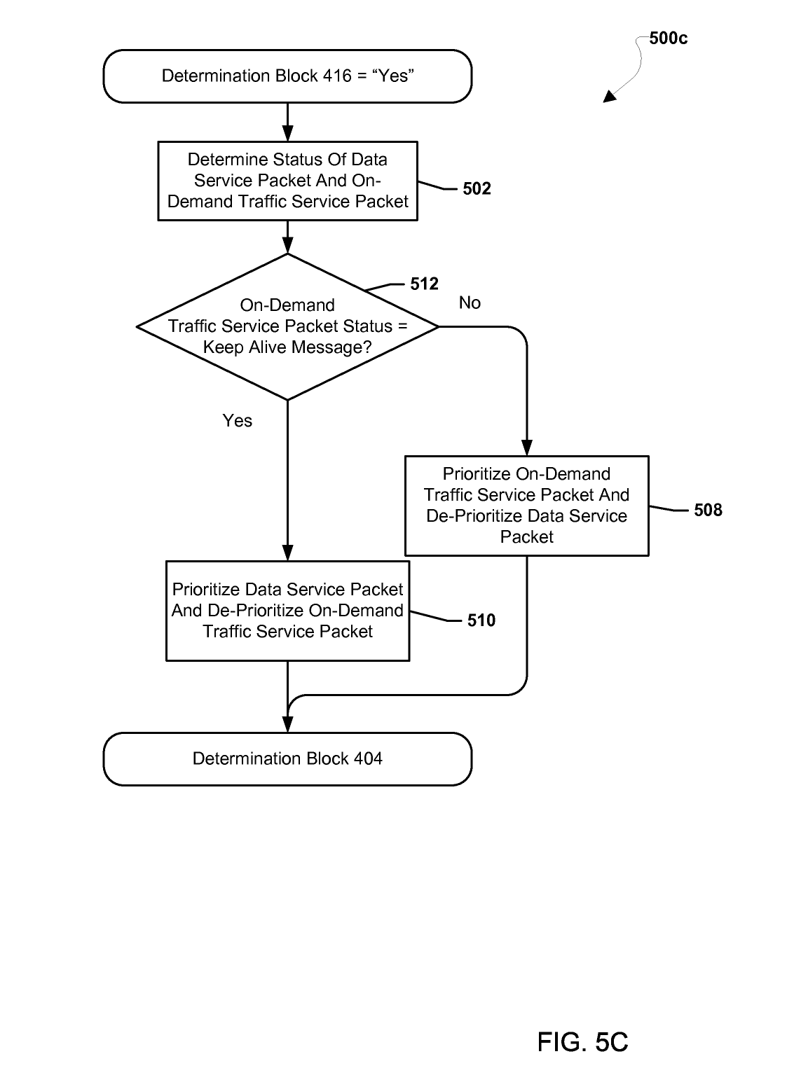

In response to determining that a coexistence event is occurring or will occur between the data service and on-demand traffic service (i.e., determination block 416=“Yes”), the device processor may apply data and on-demand traffic service coexistence rules, such as MMS coexistence rules, to prioritize and/or de-prioritize on-demand traffic service packets and data packets in block 418. As an example, the multi-active communication device processor may reference data and MMS coexistence rules (e.g., discussed with references to FIGS. 5A-5C) stored in a memory (e.g., 214) to prioritize appropriately between MMS packets and data packets such that data packets are given a lower priority than MMS packets, thereby resolving conflicts between the MMS service and data service.

FIG. 5A illustrates a method 500a for applying data and on-demand traffic service coexistence rules, such as MMS coexistence rules, to prioritize/de-prioritize on-demand traffic service packets, such as MMS packets, and data packets according to various embodiments. The method 500a may be implemented with a processor (e.g., the general processor 206 of FIG. 2, the baseband modem processor 216, the coexistence management unit 230, a separate controller, and/or the like) on a multi-active communication device (e.g., the multi-active communication device 110, 200 described with reference to FIGS. 1-3). The operations of the method 500a implement some embodiments of the operations performed in block 418 of the method 400 of FIG. 4. Thus, with reference to FIGS. 1-5A, the device processor may begin performing operations of the method 500a in response to determining that a coexistence event is or will occur between the data service and on-demand traffic service (i.e., determination block 416 of the method 400=“Yes”).

In block 502 the device processor may determine a status of each of a data packet and an on-demand traffic service packet, such as the MMS packet, resulting in the coexistence event. For example, the device processor may determine whether the statuses of the data packet and the MMS packet are a payload packet or a minimum link packet. A payload packet may be a packet of the service that carries data for the service. A minimum link packet may be a packet that is necessary to keep the radio link established via the RAT associated with the service alive, such as an overhead signaling packet. In determination block 504 the device processor may determine whether the data service packet's status is indicative of a payload. In response to the data service packet being a payload packet (i.e., determination block 504=“Yes”), the device processor may prioritize the on-demand traffic service packet and de-prioritize the data service packet in block 508. In this manner, any on-demand traffic service packet, such as any MMS packet, may be prioritized over a payload packet of the data service. In particular embodiments, this may result in the data service being paused.

In response to the data service packet not being a payload packet (i.e., determination block 504=“No”), the device processor may determine whether the on-demand traffic service packet's status is indicated as a minimum link packet for the on-demand traffic service, in determination block 506. In response to the on-demand traffic service packet being a minimum link packet (i.e., determination block 506=“Yes”), the device processor may prioritize the on-demand traffic service packet and de-prioritize the data service packet, in block 508. In this manner, minimum link packets of the on-demand traffic service, such as the MMS service, may be prioritized over minimum link packets of the data service, which may result in RLF for the data service while attempting to ensure the on-demand traffic service, such as the MMS service, is maintained.

In response to the on-demand traffic service packet not being a minimum link packet (i.e., determination block 506=“No”), the device processor may prioritize the data service packet and de-prioritize the on-demand traffic service packet in block 510. In this manner, minimum link packets of the data service may be temporarily prioritized over payload packets of the on-demand traffic service, which may prevent RLF for the data service. In response to prioritizing and de-prioritizing packets in blocks 508 or 510, the device processor may return to performing the operations of determination block 404 of the method 400 (FIG. 4).

FIG. 5B illustrates a method 500b for applying data and on-demand traffic service coexistence rules, such as MMS coexistence rules, to prioritize/de-prioritize on-demand traffic service packets, such as MMS packets, and data packets according to various embodiments. The method 500b may be implemented with a processor (e.g., the general processor 206 of FIG. 2, the baseband modem processor 216, the coexistence management unit 230, a separate controller, and/or the like) on a multi-active communication device (e.g., the multi-active communication device 110, 200 described with reference to FIGS. 1-3). The operations of method 500b implement some embodiments of the operations performed in block 418 of the method 400 of FIG. 4. Thus, with reference to FIGS. 1-5B, the device processor may begin performing operations of the method 500b in response to determining that a coexistence event is or will occur between the data service and on-demand traffic service (i.e., determination block 416 of method 400=“Yes”).

As discussed with reference to the method 500a, in block 508, the device processor may prioritize an on-demand traffic service packet, such as a MMS service packet, and de-prioritize a data service packet. In some embodiments, one or more data and on-demand traffic service coexistence rules may always prioritize on-demand traffic service packets over data service packets. In this manner, the data and on-demand traffic service coexistence rule(s), such as the MMS coexistence rule(s), applied may ensure that on-demand traffic service packets, such as MMS service packets, are always prioritized over data service packets without conditional exceptions. In response to prioritizing the on-demand traffic service packets in block 508, the device processor may return to performing operations of determination block 404 of the method 400 (FIG. 4).

FIG. 5C illustrates a method 500c for applying data and on-demand traffic service coexistence rules, such as MMS coexistence rules, to prioritize/de-prioritize on-demand traffic service packets, such as MMS packets, and data packets according to various embodiments. With reference to FIGS. 1-5C, the method 500c may be implemented with a processor (e.g., the general processor 206, the baseband modem processor 216, the coexistence management unit 230, a separate controller, and/or the like) on a multi-active communication device (e.g., the multi-active communication device 110, 200 described with reference to FIGS. 1-3). The operations of the method 500c implement some embodiments of the operations performed in block 418 of the method 400. Thus, the device processor may begin performing operations of the method 500a in response to determining that a coexistence event is or will occur between the data service and on-demand traffic service (i.e., determination block 416 of the method 400=“Yes”).

As described, in block 502 the device processor may determine a status of each of the data packet and on-demand traffic service packet, such as the MMS packet, resulting in the coexistence event. For example, the device processor may determine whether the status of the MMS packet is a keep-alive message. In determination block 512, the device processor may determine whether the on-demand traffic service packet's status is indicative of a keep-alive message. In response to the on-demand traffic service packet not being a keep-alive message (i.e., determination block 512=“No”), the device processor may prioritize the on-demand traffic service packet and de-prioritize the data service packet in block 508 as described.

In response to the on-demand traffic service packet being a keep-alive message (i.e., determination block 512=“Yes”), the device processor may prioritize the data service packet and de-prioritize the on-demand traffic service packet in block 510 as described. In this manner, data service packets of the data service may be temporarily prioritized over keep-alive messages of the on-demand traffic service. In response to prioritizing and de-prioritizing packets in blocks 508 or 510, the device processor may return to performing operations of determination block 404 of the method 400 (FIG. 4).

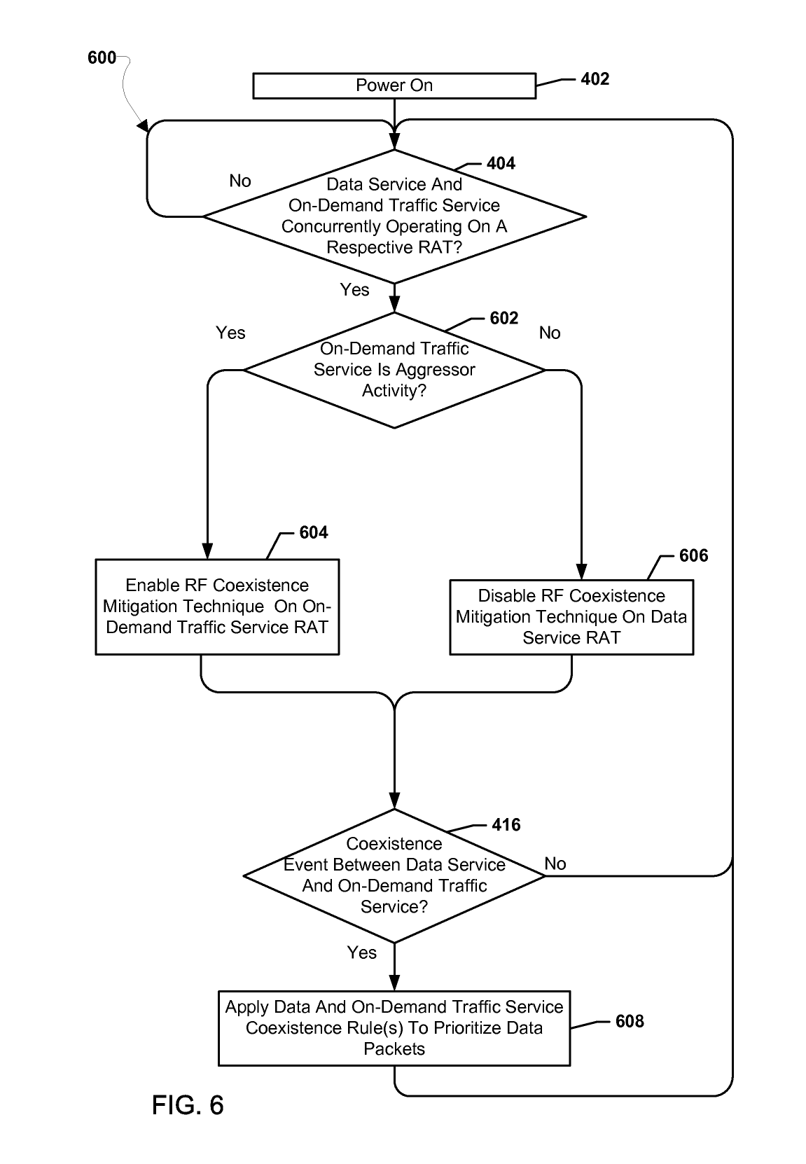

FIG. 6 illustrates a method 600 for managing a coexistence event between an on-demand traffic service, such as a MMS service, and a data service according to various embodiments. The method 600 may be implemented with a processor (e.g., the general processor 206 of FIG. 2, the baseband modem processor 216, the coexistence management unit 230, a separate controller, and/or the like) on a multi-active communication device (e.g., the multi-active communication device 110, 200 described with reference to FIGS. 1-3). In various embodiments, the operations of method 600 may be performed by the device processor on a per slot or per packet basis. With reference to FIGS. 1-6, the device processor may begin performing operations of the method 600 in response to the multi-active communication device's powering on in block 402.

In determination block 404 the device processor may determine whether a concurrent data service and on-demand traffic service, such as a MMS service, are operating on two RATs of the device. (e.g., a first RAT providing a MMS service and a second RAT providing a data service). In response to determining that a data service and on-demand traffic service are not concurrent (i.e., determination block 404=“No”), the device processor may continue to monitor the status of the RATs of the device in determination block 404.

In response to determining that a data service and on-demand traffic service are concurrently operating (i.e., determination block 404=“Yes”), the device processor may determine whether the on-demand traffic service, such as the MMS service, is the aggressor activity in determination block 602. For example, the device processor may determine whether the on-demand traffic service is transmitting on the uplink to determine whether the on-demand traffic service is the aggressor activity.

In response to determining that the on-demand traffic service is the aggressor activity (i.e., determination block 602=“Yes”), the device processor may enable one or more RF coexistence mitigation technique (e.g., Tx blanking, power back off, etc.) on the on-demand traffic service's RAT, such as the MMS service RAT, in block 604. As examples, the device processor may enable power back off and/or blanking on the RAT associated with the on-demand traffic service.

In response to determining that the on-demand traffic service is not the aggressor activity and the data service is the aggressor activity (i.e., determination block 602=“No”), the device processor may disable or otherwise not implement one or more RF coexistence mitigation technique on the data service RAT, in block 606. As examples, the device processor may prevent power back off and/or blanking on the RAT associated with the on-demand traffic service.

In response to enabling or disabling the RF coexistence mitigation techniques in blocks 604 or 606, the device processor may determine whether a coexistence event between the data service and the on-demand traffic service, such as the MMS service, is occurring or will occur in determination block 416. Coexistence events may occur when both the data service and on-demand traffic service, such as the MMS service, intend to send and/or receive at (or near) the same time. The device processor may monitor for coexistence events on a per-slot or per-packet basis. As an example, the device processor may perform a table lookup of frequency bands/channels available to the RAT associated with the data service and the RAT associated with the MMS service in an interference data table in order to identify frequency-band/channel combinations that may result in inter-RAT coexistence interference to determine that coexistence events are occurring or will occur.

In response to determining that a coexistence event is not occurring or will not occur between the data service and on-demand traffic service (i.e., determination block 416=“No”), the device processor may determine whether the data service and on-demand traffic service, such as the MMS service, are concurrently operating in determination block 404. In response to determining that a coexistence event is or will occur between the data service and on-demand traffic service (i.e., determination block 416=“Yes”), the device processor may apply data and on-demand traffic service coexistence rules, such as MMS coexistence rules, to prioritize data packets in block 608. Thus in some embodiments, the data and on-demand traffic service coexistence rules, such as the MMS coexistence rules, applied may ensure that data service packets are always prioritized over on-demand traffic service packets, such as MMS service packets, without conditional exceptions. In response to prioritizing the data service packets in block 608, the device processor may determine whether the data service and on-demand traffic service, such as the MMS service, are concurrently operating in determination block 404.

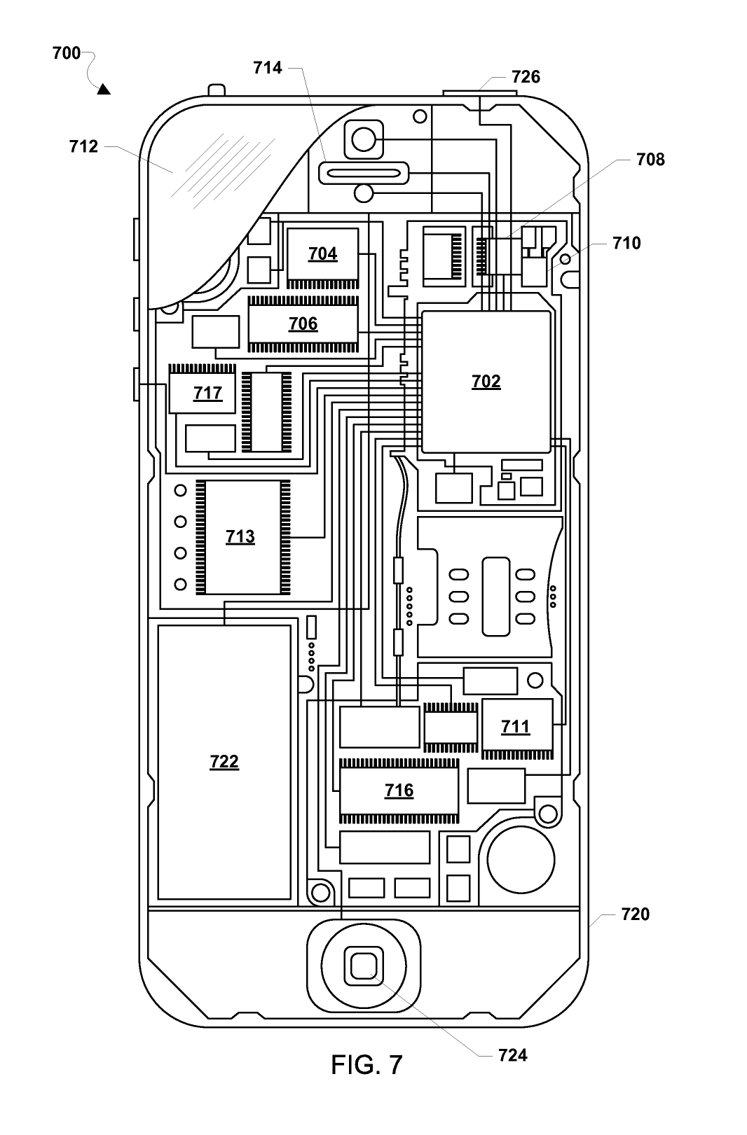

Various embodiments may be implemented in any of a variety of multi-active communication devices, an example on which (e.g., multi-active communication device 700) is illustrated in FIG. 7. According to various embodiments, the multi-active communication device 700 may be similar to the multi-active communication devices 110, 120, 200 as described with reference to FIGS. 1-3. As such, the multi-active communication device 700 may implement the methods 400, 500a, 500b, 500c, and/or 600 in FIGS. 4, 5A, 5B, 5C, and/or 6.

Thus, with reference to FIGS. 1-7, the multi-active communication device 700 may include a processor 702 coupled to a touchscreen controller 704 and an internal memory 706. The processor 702 may be one or more multi-core integrated circuits designated for general or specific processing tasks. The internal memory 706 may be volatile or non-volatile memory, and may also be secure and/or encrypted memory, or unsecure and/or unencrypted memory, or any combination thereof. The touchscreen controller 704 and the processor 702 may also be coupled to a touchscreen panel 712, such as a resistive-sensing touchscreen, capacitive-sensing touchscreen, infrared sensing touchscreen, etc. Additionally, the display of the multi-active communication device 700 need not have touch screen capability.

The multi-active communication device 700 may have one or more cellular network transceivers 708, 716 coupled to the processor 702 and to two or more antennae 710, 711 and configured for sending and receiving cellular communications. The transceivers 708, 716 and the antennae 710, 711 may be used with various circuitry to implement various methods of the various embodiments. The multi-active communication device 700 may include one or more SIM cards (e.g., SIM 713) coupled to the transceivers 708, 716 and/or the processor 702 and configured as described herein. The multi-active communication device 700 may include a cellular network wireless modem chip 717 that enables communication via a cellular network and is coupled to the processor 702.

The multi-active communication device 700 may also include speakers 714 for providing audio outputs. The multi-active communication device 700 may also include a housing 720, constructed of a plastic, metal, or a combination of materials, for containing all or some of the components discussed herein. The multi-active communication device 700 may include a power source 722 coupled to the processor 702, such as a disposable or rechargeable battery. The rechargeable battery may also be coupled to the peripheral device connection port to receive a charging current from a source external to the multi-active communication device 700. The multi-active communication device 700 may also include a physical button 724 for receiving user inputs. The multi-active communication device 700 may also include a power button 726 for turning the multi-active communication device 700 on and off.

The foregoing method descriptions and the process flow diagrams are provided merely as illustrative examples and are not intended to require or imply that the steps of various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the example non-transitory computer-readable or processor-readable storage media are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to some embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for managing a coexistence event between an on-demand traffic service on a first radio access technology (RAT) and a data service on a second RAT of a multi-active communication device, comprising:
determining whether the on-demand traffic service on the first RAT and the data service on the second RAT are occurring concurrently;
determining whether the data service on the second RAT or the on-demand traffic service on the first RAT is an aggressor activity in response to determining that the on-demand traffic service on the first RAT and the data service on the second RAT are occurring concurrently; and
enabling a radio frequency (RF) coexistence mitigation technique on the first RAT or the second RAT associated with the aggressor activity in response to determining that the data service on the second RAT or the on-demand traffic service on the first RAT is the aggressor activity.

2. The method of claim 1, further comprising:
disabling a RF coexistence mitigation technique on the first RAT or the second RAT not associated with the aggressor activity in response to determining that the data service on the second RAT or the on-demand traffic service on the first RAT is the aggressor activity.

3. The method of claim 2, wherein disabling a RF coexistence mitigation technique on the first RAT or the second RAT not associated with the aggressor activity comprises:
not enabling a RF coexistence mitigation technique on the first RAT or the second RAT not associated with the aggressor activity.

4. The method of claim 1,
wherein determining whether the data service on the second RAT or the on-demand traffic service on the first RAT is an aggressor activity comprises:
determining whether the data service on the second RAT is an aggressor activity; and
wherein enabling a RF coexistence mitigation technique on the first RAT or the second RAT associated with the aggressor activity comprises:
enabling a RF coexistence mitigation technique on the second RAT in response to determining that the data service on the second RAT is the aggressor activity.

5. The method of claim 4, further comprising:
disabling a RF coexistence mitigation technique on the first RAT in response to determining that the data service on the second RAT is not the aggressor activity.

6. The method of claim 1,
wherein determining whether the data service on the second RAT or the on-demand traffic service on the first RAT is an aggressor activity comprises:
determining whether the on-demand traffic service on the first RAT is an aggressor activity; and
wherein enabling a RF coexistence mitigation technique on the first RAT or the second RAT associated with the aggressor activity comprises:
enabling a RF coexistence mitigation technique on the first RAT in response to determining that the on-demand traffic service on the first RAT is the aggressor activity.

7. The method of claim 6, further comprising:
disabling a RF coexistence mitigation technique on the second RAT in response to determining that the on-demand traffic service on the first RAT is not the aggressor activity.

8. The method of claim 1, wherein the on-demand traffic service is a Multimedia Messaging Service (MMS) service.

9. The method of claim 1, further comprising:
determining whether the data service on the second RAT meets a blanking threshold; and
invoking flow control on the second RAT in response to determining that the data service on the second RAT meets the blanking threshold.

10. The method of claim 1, further comprising:
determining whether a coexistence event between the data service and the on-demand traffic service is occurring or likely to occur; and
applying one or more coexistence rules to prioritize packets of the on-demand traffic service in response to determining that the coexistence event between the data service and the on-demand traffic service is occurring or likely to occur.

11. The method of claim 10, wherein applying the one or more coexistence rules to prioritize packets of the on-demand traffic service comprises always prioritizing the packets of the on-demand traffic service over packets of the data service.

12. The method of claim 10, wherein applying one or more coexistence rules to prioritize packets of the on-demand traffic service comprises:
determining a status of a data service packet and an on-demand traffic service packet; and
prioritizing the on-demand traffic service packet over the data service packet in response to determining that the data service packet is a payload packet or the on-demand traffic service packet is a minimum link packet.

13. The method of claim 12, further comprising:
prioritizing the data service packet over the on-demand traffic service packet in response to determining that the data service packet is a minimum link packet and the on-demand traffic service packet is a payload packet.

14. The method of claim 10, wherein applying the one or more coexistence rules to prioritize packets of the on-demand traffic service comprises:
determining a status of a data service packet and an on-demand traffic service packet; and
prioritizing the data service packet over the on-demand traffic service packet in response to determining that the on-demand traffic service packet is a keep-alive message.

15. The method of claim 1, wherein the RF coexistence mitigation technique includes power back off, blanking, or both operations.

16. The method of claim 1, wherein the on-demand traffic service is a bursty on-demand traffic service.

17. A multi-active communication device, comprising:
a plurality of frequency (RF) resources associated with a first radio access technology (RAT) and a second RAT; and
a processor coupled to the plurality of RF resources and configured with processor-executable instructions to:
determine whether an on-demand traffic service on the first RAT and a data service on the second RAT are occurring concurrently;
determine whether the data service on the second RAT or the on-demand traffic service on the first RAT is an aggressor activity in response to determining that the on-demand traffic service on the first RAT and the data service on the second RAT are occurring concurrently; and
enable a radio frequency (RF) coexistence mitigation technique on the first RAT or the second RAT associated with the aggressor activity in response to determining that the data service on the second RAT or the on-demand traffic service on the first RAT is the aggressor activity.

18. The multi-active communication device of claim 17, wherein the processor is further configured with processor-executable instructions to:
disable an RF coexistence mitigation technique on the first RAT or the second RAT not associated with the aggressor activity in response to determining that the data service on the second RAT or the on-demand traffic service on the first RAT is the aggressor activity.

19. The multi-active communication device of claim 17, wherein the processor is further configured with processor-executable instructions to:
disable an RF coexistence mitigation technique on the first RAT or the second RAT not associated with the aggressor activity by not enabling an RF coexistence mitigation technique on the first RAT or the second RAT not associated with the aggressor activity.

20. The multi-active communication device of claim 17, wherein the processor is further configured with processor-executable instructions to:
determine whether the data service on the second RAT or the on-demand traffic service on the first RAT is an aggressor activity by determining whether the data service on the second RAT is an aggressor activity; and
enable an RF coexistence mitigation technique on the first RAT or the second RAT associated with the aggressor activity by enabling an RF coexistence mitigation technique on the second RAT in response to determining that the data service on the second RAT is the aggressor activity.

21. The multi-active communication device of claim 20, wherein the processor is further configured with processor-executable instructions to:
disable an RF coexistence mitigation technique on the first RAT in response to determining that the data service on the second RAT is not the aggressor activity.

22. The multi-active communication device of claim 17, wherein the processor is further configured with processor-executable instructions to:
determine whether the data service on the second RAT or the on-demand traffic service on the first RAT is an aggressor activity by determining whether the on-demand traffic service on the first RAT is an aggressor activity; and
enable an RF coexistence mitigation technique on the first RAT or the second RAT associated with the aggressor activity by enabling an RF coexistence mitigation technique on the first RAT in response to determining that the on-demand traffic service on the first RAT is the aggressor activity.

23. The multi-active communication device of claim 22, wherein the processor is further configured with processor-executable instructions to:
disable an RF coexistence mitigation technique on the second RAT in response to determining that the on-demand traffic service on the first RAT is not the aggressor activity.

24. The multi-active communication device of claim 17, wherein the processor is further configured with processor-executable instructions to:
determine whether the data service on the second RAT meets a blanking threshold; and
invoke flow control on the second RAT in response to determining that the data service on the second RAT meets the blanking threshold.

25. The multi-active communication device of claim 17, wherein the processor is further configured with processor-executable instructions to:
determine whether a coexistence event between the data service and the on-demand traffic service is occurring or likely to occur; and
apply one or more coexistence rules to prioritize packets of the on-demand traffic service in response to determining that the coexistence event between the data service and the on-demand traffic service is occurring or likely to occur.

26. The multi-active communication device of claim 25, wherein the processor is further configured with processor-executable instructions to apply one or more coexistence rules to prioritize packets of the on-demand traffic service by:
determining a status of a data service packet and an on-demand traffic service packet; and
prioritizing the on-demand traffic service packet over the data service packet in response to determining that the data service packet is a payload packet or the on-demand traffic service packet is a minimum link packet.

27. The multi-active communication device of claim 25, wherein the processor is further configured with processor-executable instructions to apply one or more coexistence rules to prioritize packets of the on-demand traffic service by:
determining a status of a data service packet and an on-demand traffic service packet; and
prioritizing the data service packet over the on-demand traffic service packet in response to determining that the on-demand traffic service packet is a keep-alive message.

28. The multi-active communication device of claim 17, wherein the on-demand traffic service is a bursty on-demand traffic service.

29. A multi-active communication device, comprising:
means for determining whether an on-demand traffic service on a first radio access technology (RAT) and a data service on a second RAT are occurring concurrently;
means for determining whether the data service on the second RAT or the on-demand traffic service on the first RAT is an aggressor activity in response to determining that the on-demand traffic service on the first RAT and the data service on the second RAT are occurring concurrently; and
means for enabling a radio frequency (RF) coexistence mitigation technique on the first RAT or the second RAT associated with the aggressor activity in response to determining that the data service on the second RAT or the on-demand traffic service on the first RAT is the aggressor activity.

30. A non-transitory processor-readable storage medium having stored thereon processor-executable instructions configured to cause a processor of a multi-active communication device to perform operations for managing a coexistence event between an on-demand traffic service on a first radio access technology (RAT) and a data service on a second RAT operating on the multi-active communication device, comprising:
determining whether the on-demand traffic service on a first radio access technology (RAT) and the data service on the second RAT are occurring concurrently;
determining whether the data service on the second RAT or the on-demand traffic service on the first RAT is an aggressor activity in response to determining that the on-demand traffic service on the first RAT and the data service on the second RAT are occurring concurrently; and
enabling a radio frequency (RF) coexistence mitigation technique on the first RAT or the second RAT associated with the aggressor activity in response to determining that the data service on the second RAT or the on-demand traffic service on the first RAT is the aggressor activity.
